(19) United States
(12) Patent Application Publication
(10) Pub. No.: US 2016/0350841 A1
(43) Pub. Date: Dec. 1, 2016

(54) SYSTEM AND METHOD OF E-COMMERCE

(71) Applicant: Gregor Zebic, Wallisellen (CH)

(72) Inventor: Gregor Zebic, Wallisellen (CH)

(21) Appl. No.: 15/167,250

(22) Filed: May 27, 2016

Related U.S. Application Data
(60) Provisional application No. 62/168,185, filed on May 29, 2015.

(51) Int. Cl. G06Q 30/06

(52) U.S. Cl. CPC G06Q 30/0643; G06Q 30/0633

(57) ABSTRACT

A system and method of e-commerce is provided. The system and method of e-commerce may include a web server accessed by users over the internet. The web server produces a unique product page having an index. The index includes a plurality of tiles, where each tile displays a different product to view or purchase. Users may select a tile to view or purchase the product. The action of selecting the tile includes flipping the tile 180 degrees and producing a visual of the tile flipping and displaying the back side of the tile. Selected tiles may then be added to the shopping cart page and purchased.

### CROSS-REFERENCE TO RELATED APPLICATION

This application claims the benefit of priority of U.S. provisional application No. 62/168,185, filed May 29, 2015, the contents of which are herein incorporated by reference.

### BACKGROUND OF THE INVENTION

The present invention relates to e-commerce and, more particularly, to a unique system and method of e-commerce.

Online shopping is a form of electronic commerce which allows consumers to directly buy goods or services from a seller over the Internet using a web browser. An online shop evokes the physical analogy of buying products or services at a brick and mortar retailer or shopping center; the process is called business-to-consumer (B2C) online shopping. Currently, online shopping is overly complex and does not include any personalization. There are too many products and categories, which does not facilitate a user friendly shopping experience. As can be seen, there is a need for a user and merchant friendly e-commerce system and method.

### SUMMARY OF THE INVENTION

In one aspect of the present invention, a method of providing an e-commerce platform comprises: providing a web server comprising a microprocessor and a memory, wherein the microprocessor publishes a web page accessible over an internet, wherein the web page comprises at least a product page and a shopping cart page, wherein the product page comprises a grid comprising a plurality of unselected tiles, wherein each of the unselected tiles comprises a product information of different products and a selection button, the product page further comprising an add all selected tiles to a shopping cart button; transforms at least one of the unselected tiles to a selected tile when a user activates the selection button using a computer having access to the internet; transfers the at least one selected tile to the shopping cart page when the user activates the add all selected tiles to the shopping cart button; and prompts the user to purchase the at least one selected tile within the shopping cart page.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention demonstrating the E-Commerce process;

FIG. 2 is a schematic view of an embodiment of the present invention demonstrating the relationship between merchants and buyers;

FIG. 3 is a schematic view of prior art;

FIG. 4 is a schematic view of an embodiment of the present invention;

FIG. 5 is a schematic view of an embodiment of the present invention;

FIG. 6 is a schematic view of an embodiment of the present invention;

FIG. 7 is a schematic view of an embodiment of the present invention;

FIG. 8 is a schematic view of an embodiment of the present invention; and

FIG. 9 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

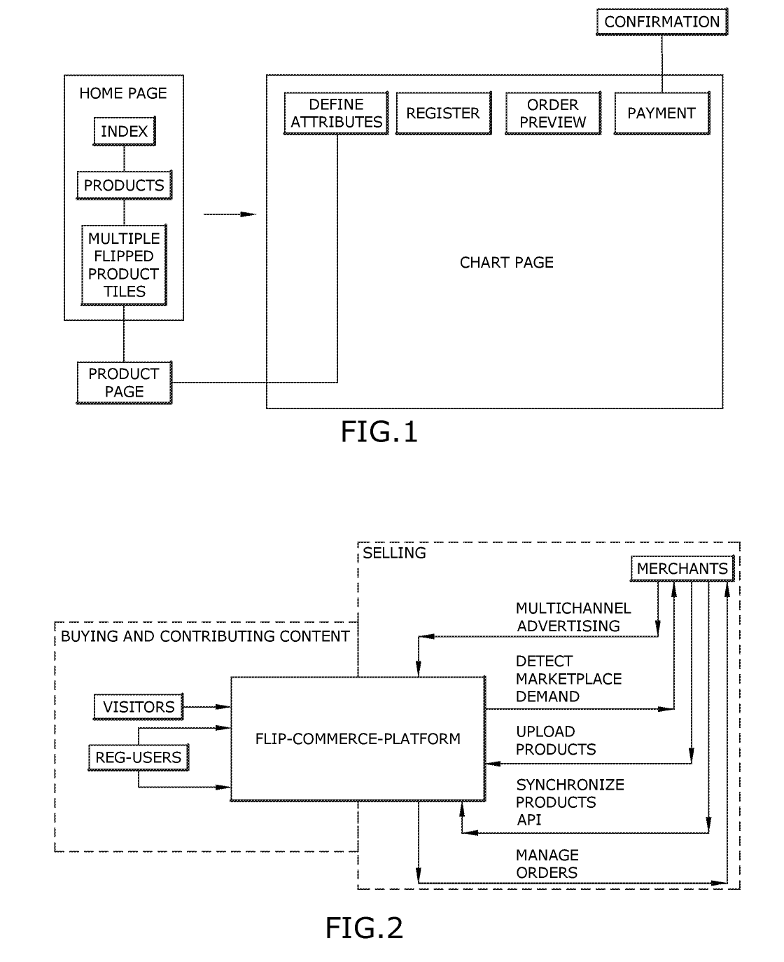

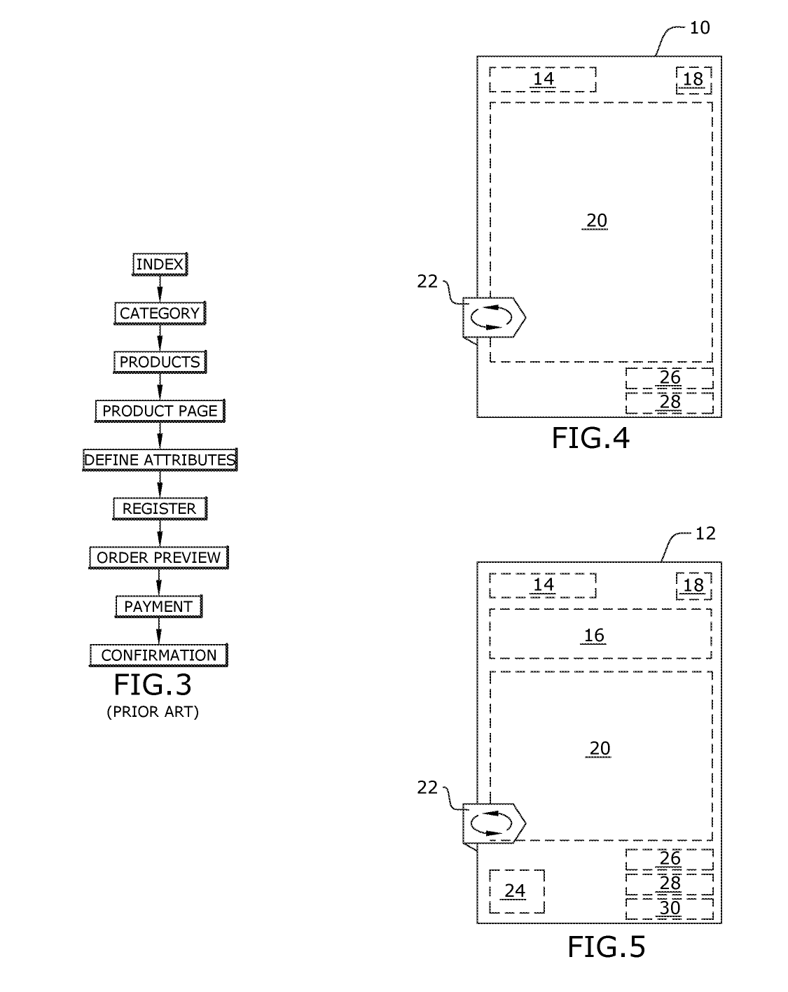

Referring to FIG. 1, the present invention includes a web server having a microprocessor and a memory. The web server is used for E-commerce and may be accessed by users over the internet. The web server produces a unique product page having an index. The index includes a plurality of tiles, where each tile displays a different product to view or purchase. Users may select a tile to view or purchase the product. In certain embodiments, the action of selecting the tile includes flipping the tile 180 degrees and producing a visual of the tile flipping and displaying the back side of the tile. Tiles may then be added to the shopping cart page. Once tiles have been selected and added to the shopping cart page, the user may define the product attributes, such as the product size, color and the like. The user further confirms the details and makes the payment for purchase.

FIG. 2 illustrates a method of producing the type of products to the user via the plurality of tiles. Visitors and regular users may visit the flip commerce platform having the product page with the plurality of tiles. Merchants may include advertisements within the grid of the plurality of tiles and may track selections of those advertisements by the users. Further, the merchants may detect market demand by what the user is selecting. When the visitor or the regular user visits the flip ecommerce platform again, the merchants or administrator of the web server may upload the type of products to the product page based on the selected advertisements as well as the selected products from previous visits. Therefore, the merchants and administrators may synchronize the product's application programming interface (API) based on previous visits. Using the present invention, merchants can promote their products, detect marketplace demand, upload the products, and manage orders or synchronize product offers with API connection.

FIGS. 4 and 5 illustrate a non-selected tile 10 and a selected tile 12. The non-selected tile 10 may include an image 20 of the product at the center of the tile. The non-selected tile 10 may further include the product title 14 and the tile number 18 located at the top of the tile on the left hand and right hand side respectfully. The non-selected tile 10 may further include the price display 26 of the product and the buy now button 28 located beneath the image 20. The price display 26 may be of the lowest price offered out of a plurality of merchants. The non-selected tile 10 also includes a button to select the tile. For example, the button may be a flip button 22.

Once the flip button 22 has been selected, the product has been selected and the tile flips to the selected tile 12. The selected tile 12 may present additional information to the user. The selected tile 12 may also include the product title 14 and the tile number 18 located at the top of the tile on the left hand and right hand ride respectfully. Further, the selected tile 12 may also include a product description 16 above the image 20 of the product. The selected tile 12 may also include the price display 26 of the product and the buy now button 28 located beneath the image 20. The selected tile 12 may further include a merchant's button 24. If the merchant's button 24 is selected, the user may review and select different types of merchants that offer the product. The prices may vary between each merchant. In certain embodiments, the selected tile 12 may also include a merchant detail button 30. The merchant detail button 30 provides additional details about the differences of each merchant. For example, the price difference, the shipping methods and the location of the merchants may be displayed.

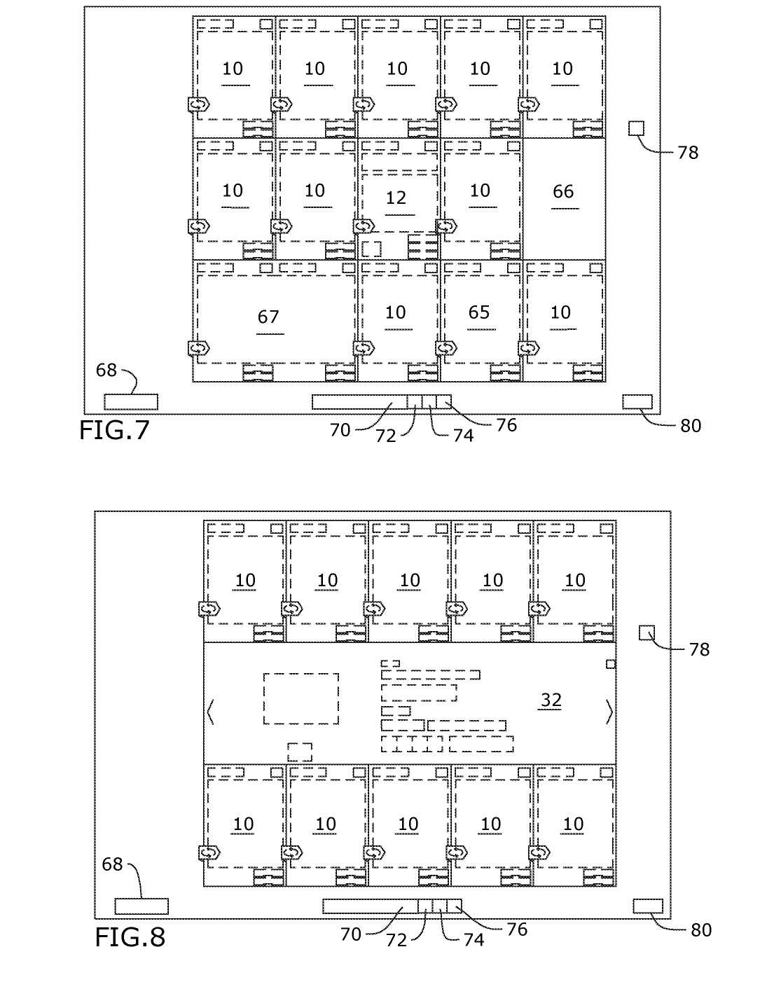

FIG. 7 illustrates an embodiment of the product page having the grid with a plurality of tiles. Initially, the product page is displayed with a plurality of tiles as non-selected tiles 10. Further, certain tiles may be in the form of banner advertisements 66 that are posted by certain merchants. The banner advertisements 66 may be used to further collect data of what the user is interested and not interested in. In certain embodiments, the present invention may produce a larger banner 67. The larger banner 67 may be selected by the web server administrators. The larger banner 67 may be selected due to the merchant paying a monetary value or because it has been deemed that the user may be more interested in this product as compared to others. The grid may further include a web administrator selected product tile 65. Additionally, the index page may include a call support button 78, a FAQ button 80, a more information button 68, a number of flipped tiles display 70, a flip all tiles button 72, an unflip all tiles button 74 and an add all flipped tiles to shopping cart button 76. Therefore, users may easily flip tiles and then add the products to their shopping cart page using the present invention.

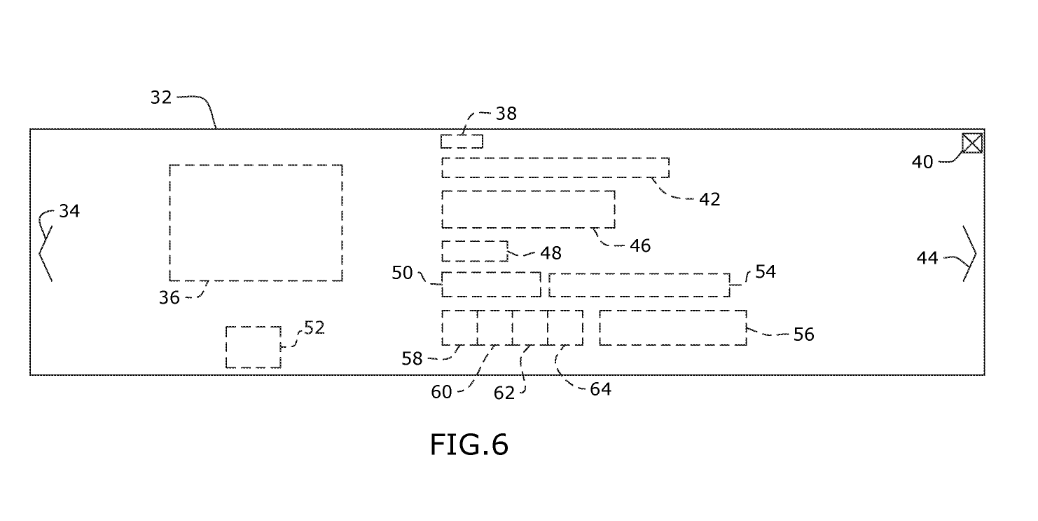

FIGS. 6 and 8 illustrate an alternate index page. The alternate index page may also include a grid having a plurality of tiles initially displayed as non-selected tiles 10. Similar to the above mentioned index page, the page may include a more information button 68, a number of flipped tiles display 70, a flip all tiles button 72, an unflip all tiles button 74 and an add all flipped tiles to shopping cart button 76. Further, the index of FIG. 8 may include an expanded product tile 32. As illustrated in FIG. 6, the expanded product tile 32 includes a larger image 36 and a more image button 52. Further, the expanded product tile 32 may include a product rating 38, a product title 42, product information 46, a product pricing 48, a quantity selection 50 providing a user with a quantity amount that may be placed in the shopping cart, an add to shopping cart button 54, a button to open the product page 58, an add product to shipping list button 60, an add product to a comparison list button 62, an open all products by this merchant button 64 and a special information button 56 that may include information such as product ingredients, region, allergens and the like. Further, the expanded product tile 32 may include a previous product button 34 for enlarging a product of a previous tile and a next product button 44 for enlarging a product of the next tile in the order on the grid. An exit button 40 may be placed at the top right hand corner of the expanded product tile 32 used to exit the expanded product tile 32.

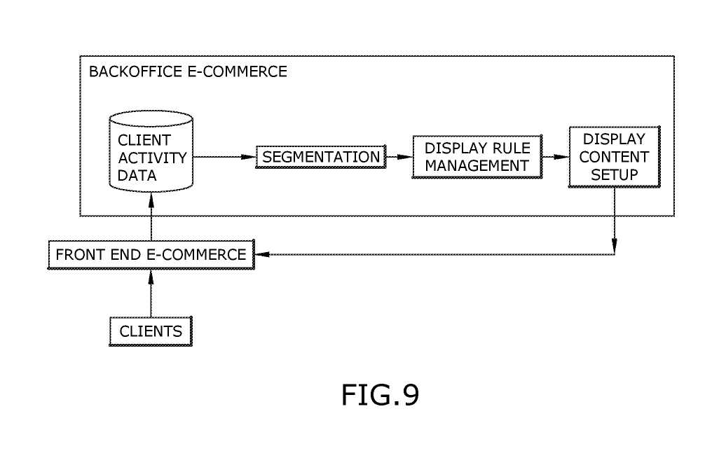

FIG. 9 further illustrates the front and e-commerce that the clients view and the back end in which the products of the tiles are selected. The front end includes the grid with the tiles as mentioned above. The client views and purchases different products on the published grid. The data is collected by the merchants and/or the administrator of the web server. The segmentation is based on the user data which targets the user with product tiles and advertising on the platform. Advertising may be based on the preset rules. Further, the web server and/or merchants determine which products are included on the advertising banners and the double sized product tiles on the shopping platform.

### Marketing Process:

Products with all attributes are inserted or imported (synchronized with other software) to the ecommerce back-office system. Administrator creates different levels of customers (groups like loyalty members based on volume of orders) inside back-office. Administrators also setup the general parameters like packaging, delivery pricing and configuration.

The general marketing rules are created within administration panel. Admin creates a segment of users based on their attributes (example: all registered users with total spend more than $100, geo located in specific cities, number of flipped tiles more than 50, last purchases more than month ago). Than administrator defines marketing campaign rules based on parameters: Product ID (product or banner that will be marketed/inserted into the grid), Position (on what position on the grid the inserted product or banner will show-up), and Frequency (How frequent the inserted product or banner will be shown), Size (1, 2 or 4 tile size), type (inserted product or banner). Created rules may also have priority parameters from 1 to 10 so rules can't overlap.

### User Interaction:

When a visitor user goes to the web server over the internet, the intelligent grid is presented to the user with generic products (for example: top 50 products from top 5 categories based on overall ecommerce platform sales.) When a user logs in to the system and has previously used the present invention, the grid is personalized based on the user's previous orders. The user sees known products (images) which are shown based on an algorithm. The algorithm may include:

From last 300 orders of the users top 3 categories based on bought products are defined plus last 50 products ordered. Grid display first 50 products that user bought recently, and then display random products from top 3 categories based on last 300 purchases. User also sees inserted products and/or banners based on marketing rules.

### Shopping Experience:

When users interact with the website all the activities are stored to user attributes. The tiles are selected based on these attributes.

### Flipping Tiles Experience:

When user scrolls through the web server, products are loaded based on previously explained logic. The user can flip the product tile and get more information about the product. The user can flip desired products inside the grid and then use the button below to add all flipped products to the shopping cart with one click. This causes the volume of the shopping cart by products to be bigger and generated quicker than inside the present known e-commerce solutions.

### Filtered Grid View Experience:

User can filter the grid view by filters like product price, category, brand, allergens, ingredients, sales, special attributes and the like. The grid automatically shows the products based on filters chosen. The present invention may also provide the option to save the search parameters for the filter.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing an e-commerce platform comprising:
providing a web server comprising a microprocessor and a memory, wherein the microprocessor
publishes a web page accessible over an internet, wherein the web page comprises at least a product page and a shopping cart page, wherein the product page comprises a grid comprising a plurality of unselected tiles, wherein each of the unselected tiles comprises a product information of different products and a selection button, the product page further comprising an add all selected tiles to a shopping cart button;
transforms at least one of the unselected tiles to a selected tile when a user activates the selection button using a computer having access to the internet;
transfers the at least one selected tile to the shopping cart page when the user activates the add all selected tiles to the shopping cart button; and
prompts the user to purchase the at least one selected tile within the shopping cart page.

2. The method of claim 1, wherein the unselected tile and the selected tile comprises a buy it now button.

3. The method of claim 2, wherein the selected tiles further comprises a merchant detail button, a product short description and a buy it now details button.

4. The method of claim 1, wherein the selection button is a flip button, wherein the microprocessor
produces a visual of the unselected tile flipping and displaying the selected tile during the transforming step.

5. The method of claim 1, wherein the microprocessor
stores data comprising user interaction with the product page; and
produces the grid comprising the plurality of unselected tiles, wherein the different products are based on the data.

6. The method of claim 1, wherein the microprocessor
transforms a plurality of unselected tiles to a plurality of selected tiles when the user activates a plurality of selection buttons using a computer having access to the internet;
transfers the plurality of selected tiles to the shopping cart page when the user activates the add all selected tiles to a shopping cart button; and
prompts the user to purchase the plurality of selected tiles within the shopping cart page.

7. The method of claim 1, wherein the product information comprises at least a product image, a product title, and a product price.

8. The method of claim 1, wherein at least one of the plurality of tiles comprises an advertisement link to a separate web page.

9. The method of claim 1, wherein at least one of the plurality of tiles comprises an expanded tile comprising a larger size than other tiles, wherein the expanded tile comprises a selection button operable to change a type of product being displayed within the expanded tile.

10. The method of claim 9, wherein the expanded tile further comprises at least one of a more image button, a product rating, a quantity selection, a button to open the product web page, an add product to shipping list button and an add product to a comparison list button.
